(19) United States
(12) Patent Application Publication
(10) Pub. No.: US 2021/0354965 A1
(43) Pub. Date: Nov. 18, 2021

(54) DEVICE FOR PICKING UP AND TRANSPORTING LOADS

(71) Applicant: Rogama BV, Valkenburg (NL)

(72) Inventor: Rob Matti, Valkenburg (NL)

(21) Appl. No.: 16/635,797

(22) PCT Filed: Aug. 1, 2018
(86) PCT No.: PCT/EP2018/070908

§ 371 Date: Jan. 31, 2020

(30) Foreign Application Priority Data
Aug. 1, 2017 (DE) 10 2017 213 236.1

(51) Int. Cl. B66F 9/14

(52) U.S. Cl. CPC B66F 9/143

(57) ABSTRACT

A device according to the invention for handling and transporting loads can be installed on a mobile or stationary facility. The device according to the invention is characterised in that the first guide profile has a hollow profile and the first guide profile has a drive element integrated at least partially inside the guide profile, wherein a tappet plate is operatively connected to the drive element and the guide of the tappet plate is also at least partially integrated and supported in the guide profile, wherein the drive element and the guide of the tappet plate are placed on one axis, wherein the first guide profile has a longitudinal slit through which a holder of the tappet plate protrudes, wherein a load handling element each can be operatively connected to a tappet plate.

The invention refers to a device and a system for handling and transporting loads that are attached or to be attached to a different facility. That facility may be a stationary or a movable facility, and the movable facility may be, for example, a vertically movable lifting carriage of an industrial truck.

Such devices for handling loads may be, for example, integrated into an industrial truck or designed as an attachment that is attached or to be attached to a facility such as a forklift. They usually have two load handling elements that face each other, which may, for example, take the form of two fork tines that point towards each other. This movability of the fork tines is achieved by the correspondingly designed adjustment devices and permits users to adjust the fork tines to the width of an object to be handled or the recesses in it that take up the fork tines.

In many cases, the load handling elements may not only be moved towards each other and away from each other, but also both may also be moved in parallel and in the same direction at the same time, in order to compensate for an imprecise approach with the industrial truck without maneuvering the entire vehicle. This lateral shifting movement is enabled by the same drive elements as movement of the load handling elements towards each other and away from each other. The respective adjustment devices are actuated by the operator of the industrial truck from the workstation without requiring him to get off of it.

Since such load-handling devices usually are used intensely in relatively harsh environments, the robustness of the design is an important requirement criterion. The load to be handled always comes into contact with the device directly, and protruding parts of the load or too-rough handling of the load may cause damage.

A device that comprises two load handling elements that are each attached to horizontally movable sliding arms that can be moved relative to each other, wherein the sliding arms are supported on at least one sliding guide body and can be moved a sliding guide body by the drive elements is known from the German disclosure document DE 10 2011 002 433 (A1) to transport loads. Additionally, the load handling elements each are attached to movable guide arms that are guided on a guide rail, with the sliding guide body and the guide rail being connected to each other by two connection elements and at a distance from each other. The drive elements are partially arranged inside of the sliding guide body and the sliding arms are movably guided within the sliding guide body, with the sliding guide body having a longitudinal slit through which a connecting section of the sliding arm protrudes from the sliding guide body and is connected to a load handling element. When operating the device, the greatest part of the respective drive element is placed within the sliding guide body. The sliding guide body thus reaches at least partially around both the drive elements and the sliding arms, so that they are placed advantageously protected in a sliding guide body that serves to guide the sliding arms at the same time. Damage and failure of the industrial truck can thus be reduced, and the maintenance costs remain low. At the same time, the device can have a compact design, in order to also ensure a good view of the load handling elements by the operator and to permit cost-efficient production. This design is detrimental in that two sliding guide bodies are placed on top of each other and limit the free cross-section for the view of an industrial truck's operator through the device in spite of the compact design. Beyond this, the load handling elements, i.e. the fork tines, must have special holders for the drive elements for the lateral shifting movement. In other words, standard fork tines cannot be installed on the device.

A fork positioning arrangement on a lift truck is known from the international patent application WO 2016/205 376 A1. The device has a first fork positioner and a second fork positioner, with the fork positioners being connected to a fork frame. The first fork positioner is essentially built mirror-inverted to the second fork positioner. Each fork positioner comprises a tube with an inner cavity where a piston and a carrier are arranged, both of which are coupled with a rod. The piston and the carrier are both in sliding contact with the tube. Each fork positioner has a fork holder that is arranged outside of the tube, with the fork holder being coupled to the carrier through a slit in the tube. The part of the carrier coupled to the fork holder is located between a first carrier sleeve and a second carrier sleeve. Due to the fork frame, the fork positioning arrangement is built rather large, which reduces the free cross-section between the fork positioners and therefore the ability of the operator of an industrial truck on which the fork positioning arrangement is attached to look through it.

The task of the invention therefore is providing a device for handling loads that improves the device known from the state of the art in that standard load handling elements can be used while also maximising the free cross-section to allow an operator of the industrial truck on which the device is installed to look through it, wherein the device is built compactly and has a low construction depth. Another task of the invention is providing a system for handling and transporting loads for installation on movable or stationary facilities.

The invention solves this task by a device with the features of the independent claim 1. Advantageous further developments of the device result from the dependent claims 2-18. The further task is solved by a system in accordance with claim 19. A beneficial further development of the system results from claim 20.

A device according to the invention for handling and transporting loads can be installed on a mobile or stationary facility. A mobile facility can be, e.g., an industrial truck, such as a forklift truck. A stationary facility can be, e.g., a stationary lifting device. The device comprises at least one first guide profile, wherein at least two load handling elements can be mounted on the first guide profile, wherein the at least two load handling elements can be moved relative to each other and in parallel to each other in the longitudinal direction of the first guide profile through at least one drive element each. A movement relative to each other permits adjustment of the distance of the load handling elements from each other. Movement in parallel to each other is a so-called lateral shifting movement, through which, for example, a forklift truck operator can pick up or put down a load without having to manoeuvre the forklift truck precisely, since he is able to target pick-up points of a load the load handling elements that correspond to the distance of the load handling elements even if they are not placed precisely in the positions of the load handling elements.

The device according to the invention is characterised in that the first guide profile has a hollow profile and the first guide profile has a drive element integrated at least partially inside the guide profile, wherein a tappet plate is operatively connected to the drive element and the guide of the tappet plate is also at least partially integrated and supported in the guide profile, wherein the drive element and the guide of the tappet plate are placed on one axis, wherein first guide profile has a longitudinal slit through which a holder of the tappet plate protrudes, wherein one load handling element each can be operatively connected to a tappet plate. The drive elements are protected well from external influences by the position of the drive element inside the first guide profile. The load handling elements can be easily inserted into the tappet plates, so that standard load handling elements such as, for example, standard fork tines, can be used, which can nevertheless perform lateral movements relative to each other or in parallel to each other. By integration of the guide and bearing of the tappet plate in the first guide profile, the size of the device is minimised, and the cross-section is maximised for letting an operator of an industrial truck look through it. The first guide profile forms the supporting construction element. In other words, the first guide profile supports the at least two load handling elements. No further supporting structure is required, which makes the device according to the invention built extremely compact and with a low construction depth.

In one preferred embodiment, the device has a second guide profile essentially arranged in parallel to the first guide profile in addition to the first guide profile, wherein the guide profiles are connected to each other at a distance by at least one connection element arranged essentially vertically to the guide profiles. The at least one connection element can form a frame structure with the guide profiles, with which the device can be exchangeably mounted on, e.g., a forklift truck as an attachment. In another embodiment, vertically arranged mast sides that are directly supported in the lifting framework of the industrial truck form two connection elements and, together with the two guide profiles, a frame that stabilises the device. The second guide profile may have a hollow profile like the first guide profile, wherein a drive element can be integrated at least partially inside the second guide profile as well, wherein a tappet plate is operatively connected with that drive element as well, and wherein the guide of a tappet plate is potentially also at least partially integrated and supported in the second guide profile, wherein the drive element and the guide of the tappet plate are also placed in one axis, so that at least also the second guide profile has a longitudinal slit through which the holder of a tappet plate protrudes outwards. The second guide profile can help carry the load handling elements in this.

It has turned out to be of advantage if every drive element can be operatively connected to a drive unit on the one side and to a tappet plate on the other side.

In a preferred embodiment, at least one drive element has a spindle, e.g. a ball screw.

In another preferred embodiment, at least one drive element has a fluid cylinder, e.g. a hydraulic or a pneumatic cylinder.

In another preferred embodiment, the drive unit has a hydro motor.

In another preferred embodiment, the drive unit has an electric motor.

A drive unit drives one or two drive elements. For example, the drive unit can be arranged centred in a guide profile, e.g. in the first guide profile, and drive two drive elements that are arranged on either side of the drive unit in the direction of the guide profile. This may be done via a gear or directly. If the drive unit and the two drive elements that are operatively connected to the two tappet plates are arranged in only one guide profile, the second guide profile serves only to support and guide the load handling elements. This can be done directly or indirectly via the tappet plates. It is also possible that, for example due to a larger and more stable design of the first guide profile, a second guide profile can be dispensed with.

In an alternative embodiment, both guide profiles have one drive element each. Both guide profiles can have a drive unit in this. It is also possible that only one guide profile has a drive unit or that no guide profile has a drive unit. In this case, the tappet plates can be driven via a fluid cylinder with a piston and piston rods, wherein the fluid may be, for example, compressed air or hydraulic fluid that is provided by a central system, e.g. the hydraulic unit of an industrial truck on which the device is installed.

Preferably, a drive unit is installed in the form of a hydro motor or an electric motor, in combination with a rotating element, e.g. a spindle, as drive element. For example, ball screws or threaded spindles may be used for this. A hydro motor or an electric motor can be preferably used for the drive of a rotatingly movable drive element or for parallel driving of two rotatingly movable drive elements. If two rotatingly movable drive elements are connected to only one drive unit, the insertion of a gear, in particular a switchable gear, between the drive unit and at least one drive element can reverse its movement direction while the second drive element continues to rotate in the same direction. This permits movement of the tappet plates opposite to each other or away from each other as well as movement of the tappet plates in the same direction in the form of a lateral shifting movement.

If two drive units are installed, the insertion of a gear for the two movement types of the tappet plates in relation to each other can be dispensed with. In such an embodiment, combination of different drive units is possible as well. The combination of different drive elements, e.g. a spindle and a linear cylinder, e.g. a fluid cylinder in the form of a pneumatic or hydraulic cylinder, are possible as well.

A preferred embodiment of the device is characterised in that the at least one first and the at least one second guide profile are connected to each other at a distance by the two connection elements that are arranged essentially vertically to the guide profiles. Thus, the guide profiles form a frame with the connection elements that maximises stability of the device.

In another preferred embodiment of the device, the longitudinal slits of the at least one first and the at least one second guide profile face each other. In the preferred manner of arrangement of the longitudinal slits to each other, the first and the second guide profiles have a maximal distance from each other, which further maximises the free cross-section through which an operator of an industrial truck can look.

In an alternative embodiment, the guide slits face forward, i.e. in the direction of the load handling elements or the travelling direction of the industrial truck.

It has turned out to be of advantage if the two guide profiles are arranged essentially horizontally on top of each other, so that the first guide profile is located above the second guide profile and the longitudinal slit of the second guide profile on the top of the second guide profile is in the direction of the first guide profile, wherein the longitudinal slit of the second guide profile is closed via a protective element that is moved along with the tappet plate, e.g. a strip. The horizontal arrangement of the guide profiles on top of each other is the common arrangement for attachment of the device, e.g. to a forklift truck. In this arrangement, the longitudinal slit of the lower, second guide profile points upwards. The protection element moved along with the tappet plate closes this longitudinal slit upwards, so that the risk of contamination is minimised. The longitudinal slits have a length corresponding to the maximal movement path of the tappet plates.

Furthermore, it has turned out to be of advantage if the drive elements have fluid-operated cylinders with one cylinder housing and a piston rod each, wherein the attachment means, and guide means for the respective tappet plate are at least partially integrated in the respective cylinder housing. Usually, a forklift truck is supplied with pressurised hydraulic oil, so that it is beneficial to perform the drive elements as hydraulic cylinders.

It has turned out to be of advantage if the cylinder housing and guide of the respective tappet plate are designed as a single piece. In this, the hydraulic oil is routed to the cylinder housing through two ducts in the piston rod connected to the connection head.

Integration of the attachment and guide means for the tappet plates in the cylinder housing saves parts and further minimises the build, which further maximises the free cross-section through which an operator of an industrial truck can look. Another advantage is that the connections to the main cylinder via a connection head are directly adjacent to each other, which minimises the effort for the hydraulic connection.

Pneumatic cylinders are also possible as the drive element. However, the invention also comprises other drive elements, such as electrical drive elements.

In another preferred embodiment, the guide profiles have an essentially rectangular outer cross-section with an essentially round cavity aligned in the axis direction of the respective guide profile. The essentially rectangular outer cross-section increases the stability of the guide profile and facilitates the attachment of the load handling elements. The essentially round cavity facilitates mounting of fluid-operated cylinders that usually have an essentially round outer cross-section. In an alternative embodiment, the cavity may also have a different, e.g. rectangular or oval, cross-section.

In an alternative embodiment, the cylinder is deep-drilled in the respective guide profile.

The guide profiles may have a holding profile for the hook attachment of the load handling equipment. The load handling elements can be attached to the upper guide profile, wherein they are carried by the upper guide profile and supported by the lower guide profile.

Furthermore, the longitudinal slits are preferably formed so that they keep the tappet plates in the vertical position and turning away is prevented. For this, the longitudinal slits can have, for example, guides for the tappet plates. This can be achieved, for example, in that the holder of the respective tappet plate is firmly connected to the respective cylinder housing as a cuboid elevation and protrudes through the respective longitudinal slit of the respective guide profile, wherein the dimensions of the cuboid elevation and the width of the respective longitudinal slit are coordinated with each other so that the cuboid elevation can be supported vertically to the lateral shifting direction on the side walls of the respective longitudinal slit. Additional wear elements can be attached there.

In a preferred embodiment, at least one guide profile reaches around the drive element arranged inside it by more than half. It has turned out to be of particular advantage if both guide profiles reach around the respective drive element by more than half. Furthermore, it has turned out to be of particular advantage if the degree of surrounding of at least one guide profile is more than 75%. The guide profile reaching around the drive element protects the drive element in the guide profile and holds it so that it cannot bend or fold out even at application of great force.

In another preferred embodiment, each tappet plate is powered via the drive element in a guide profile and additionally guided by the other guide profile as well, which increases the stability of the overall structure.

In another preferred embodiment, each tappet plate has a holding profile for holding the load handling equipment, wherein the holding profile can be adjusted to the width of the load handling equipment. By adjustment of the width of the holding profile of the tappet plate to the width of the load handling equipment, various pieces of load handling equipment, e.g. fork tines of different width, can be mounted on the device, which increases flexibility in operation. Adjustment of the width of the holding profile of the respective tappet plate can be achieved, e.g., in that the holding profile is formed as a U-profile, wherein the U-profile is designed divided with a fixed and an exchangeable part, wherein it is possible to connect the fixed and the exchangeable part being removably to each other, e.g. by screwing them together, and exchangeable parts of different width are provided.

A system according to the invention for handling and transporting loads for mounting on mobile or stationary facilities comprises at least one load handling element and the device according to the invention.

In a preferred embodiment of the system, the first guide profile has a holding profile with a protruding strip on one of its outer sides, with the at least one load handling element being attachable to the holding profile with an attachment profile worked mirror-inverted to the holding profile, wherein the attachment profile has a sliding piece that is applied to a protruding strip of the holding profile when the load handling element is attached to the holding profile. The sliding piece minimises the friction in the lateral adjustment of the load handling element, which means that less energy is needed for lateral adjustment of the load handling element and wear is minimised.

Further advantages, special features and suitable further developments of the invention result from the dependent claims and the following presentation of preferred embodiments based on the figures.

The figures show:

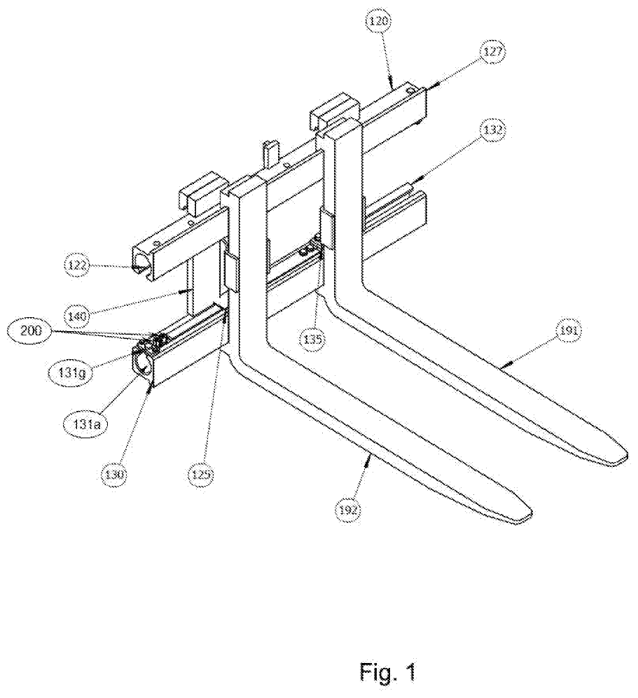

FIG. 1 a three-dimensional front view of an embodiment of the system according to the invention with load handling elements in a narrow position

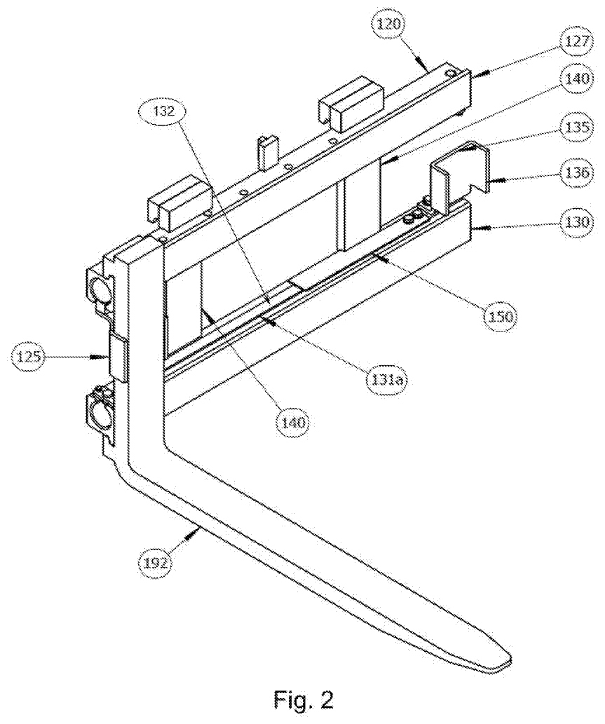

FIG. 2 a three-dimensional front view of an embodiment of the system according to the invention with only one attached load handling element in an outer position

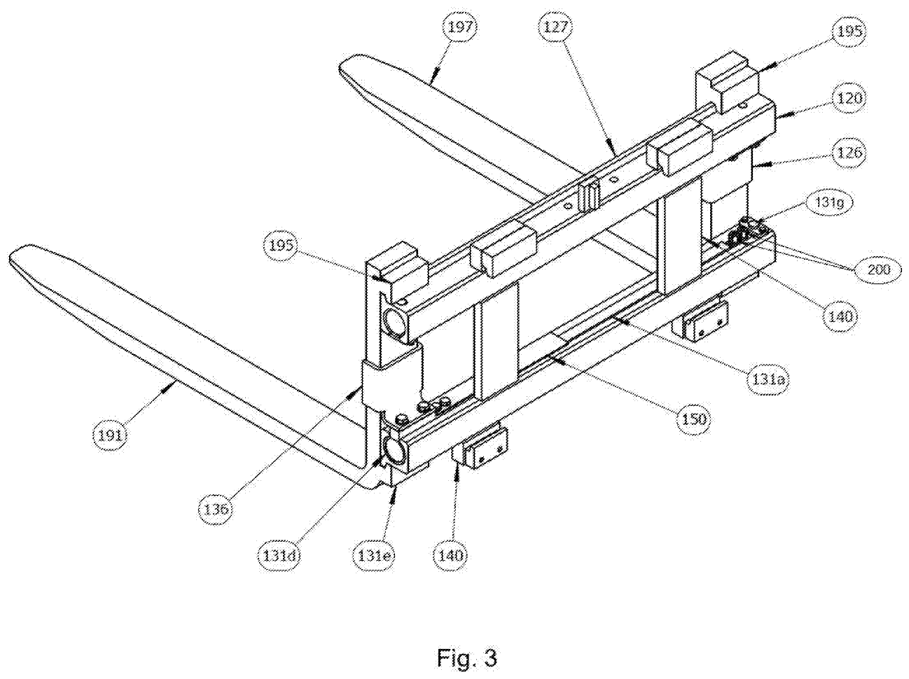

FIG. 3 a three-dimensional rear view of an embodiment of the system according to the invention with load handling elements in an outer position

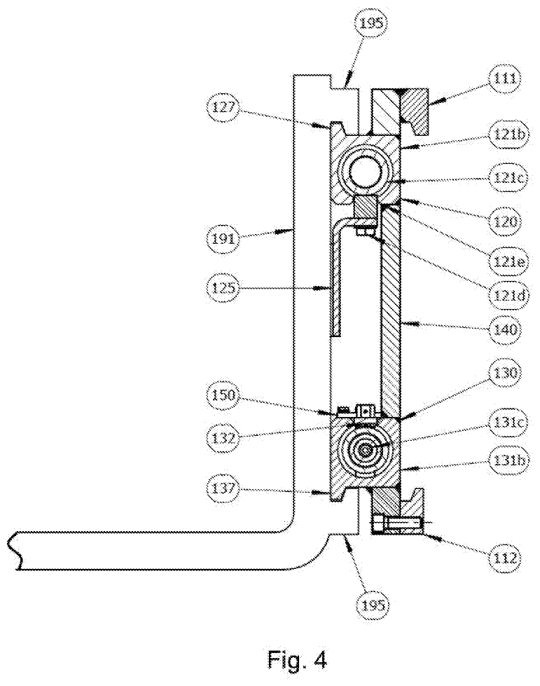

FIG. 4 lateral section of a system according to the invention

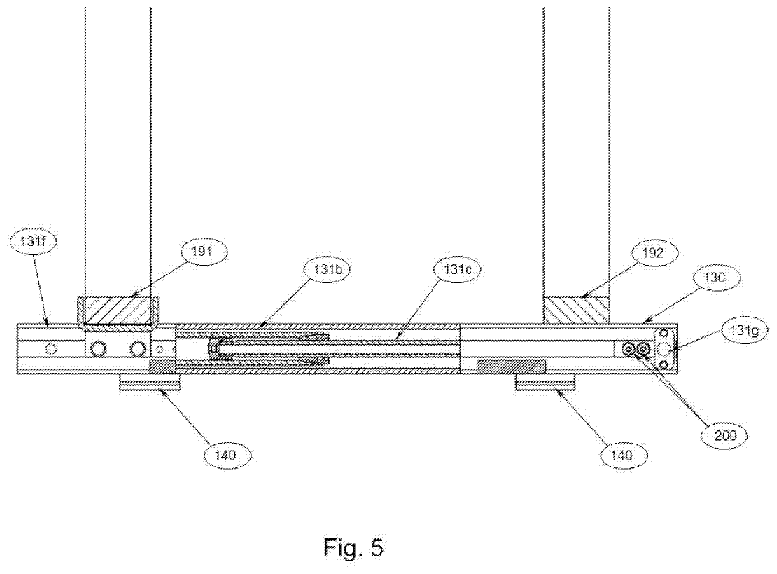

FIG. 5 section from above through the second guide profile

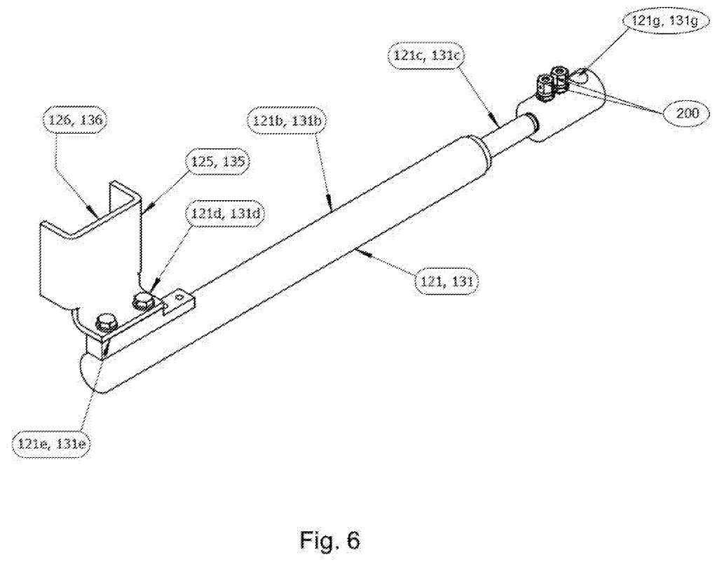

FIG. 6 three-dimensional illustration of a drive element with tappet plate

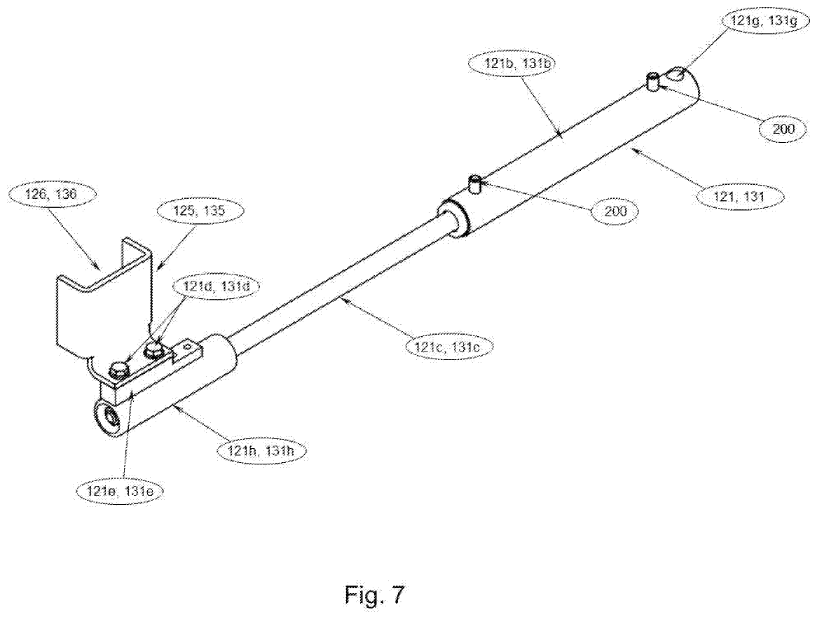

FIG. 7 three-dimensional illustration of another embodiment of a drive element with tappet plate

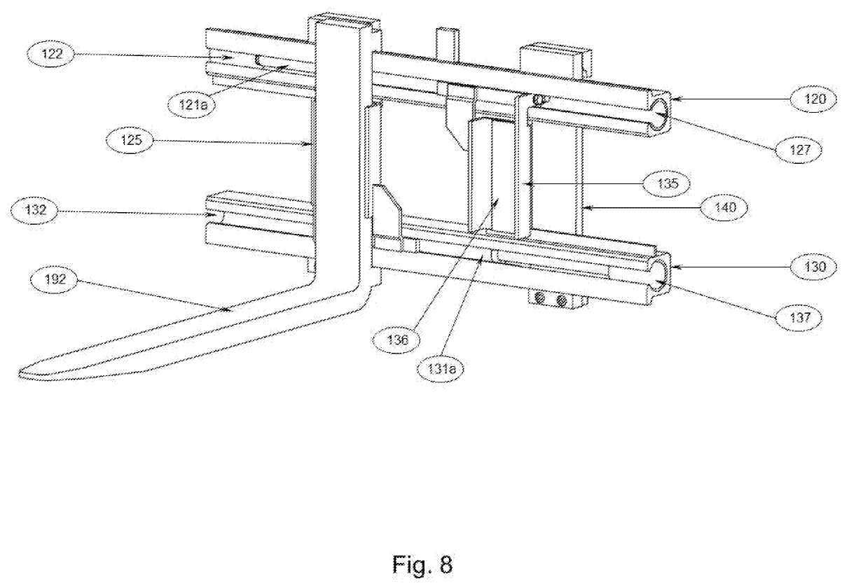

FIG. 8 a three-dimensional front view of another embodiment of the system according to the invention with only one load handling element attached

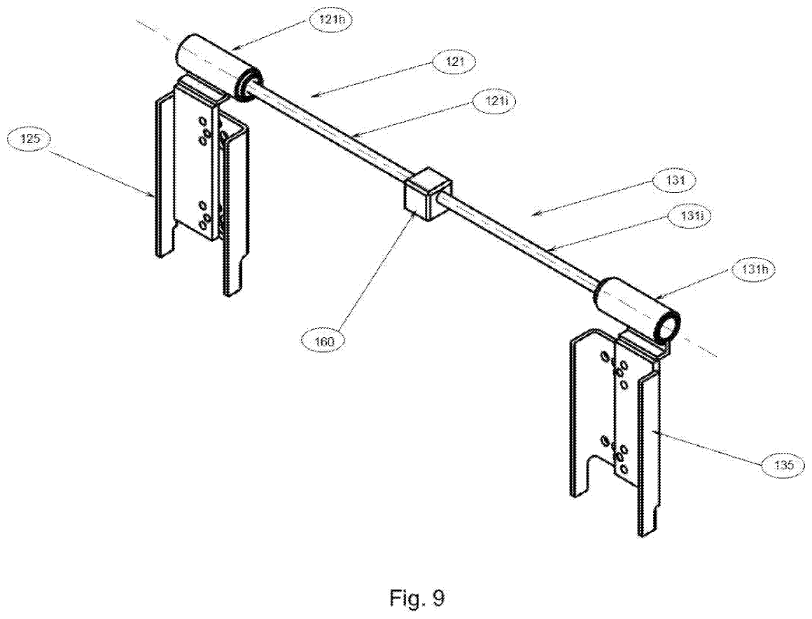

FIG. 9 three-dimensional illustration of another embodiment of a drive element with tappet plate

FIG. 1 shows a three-dimensional front view of an embodiment of the system according to the invention 100 with load handling elements 191, 192 in a narrow position. In a first upper guide profile 120, two fork tines 191, 192 are attached. The fork tines 191, 192 are supported on a second, lower guide profile 130. The first guide profile 120 and the second guide profile 130 are arranged in parallel to each other and connected at a distance from each other by two vertical connection elements 140 in a frame-like manner. The load handling elements 190, 191 are connected by tappet plates 120, 135 that can in turn be moved horizontally relative to each other or in parallel to each other in the longitudinal direction of the guide profiles 120, 130 via drive elements 121, 131. The two guide profiles 120, 130 each have a hollow profile, wherein one drive element 121, 131 is integrated inside the respective guide profile 120, 130 in each guide profile 120, 130. Each guide profile 125, 135 has a longitudinal slit 122, 132 through which the holder of the respective tappet plate 125, 135 protrudes. The second longitudinal slit 132 in the second, lower guide profile 130 is facing outwards and therefore susceptible to the occurrence of contamination. A protection element 150 that is moved along with the second tappet plate 135 in the form of a strip closes this second longitudinal slit 132 upwards, thereby preventing contamination of the cavity in the second guide profile 130.

FIG. 2 shows a three-dimensional front view of an embodiment of the system according to the invention 100 with the second load handling element 192 that is attached to the first guide profile and in an outer position, i.e. in the position extended maximally from the centre of the device 110. The second tappet plate 135 is empty, so that the holding profile 136 is visible in the second tappet plate 135. The holding profile 136 in this embodiment comprises a U-shaped profile sized in width so that the two legs of the U can partially enclose the load handling elements 191, 192 used. The tappet plates 125, 135 create the connection of the lateral shifting drive to the fork tines 191, 192. Standard fork tines 191, 192 can be used due to the shape of the holding profile 126, 136.

FIG. 3 shows a three-dimensional rear view of an embodiment of the system according to the invention 100 with fork tines 191, 192 in an outer position. In this view, the guide means 121e, 131e are visible. On the one hand, the guide means 121e, 131e have the respective holder of the respective tappet plate 126, 136 in the form of a cuboid elevation on the respective end of the respective cylinder housing 121b, 131b opposite from the exit side of the respective piston rod 121c, 131c that protrude through the longitudinal slits 122, 132 towards the respective tappet plate 125, 135, wherein the longitudinal slits 122, 132 are designed so that they support and guide the cuboid elevations in the direction vertical to the movement direction. For this, the respective drive element 121, 131 is on one axis with the guide of the respective tappet plate 125, 135.

FIG. 4 shows a lateral section of a system according to the invention 100. The device 110 has a first upper attachment profile 111 and a second lower attachment profile 112 with which the device 110 can be installed on a movable or stationary facility, such as an industrial truck, by being attached to a corresponding counter-profile, e.g. of a vertically movable lifting carriage of the forklift truck. In the displayed embodiment, the first attachment profile 111 is firmly connected to the device 100, e.g. by welding. In contrast to this, the second attachment profile 112 is screwed to the device 100 so that the device 100 can initially be attached to the counter-profile of a lifting carriage with the first attachment profile 111 and then the second attachment profile 112 can be screwed on, so that the device is firmly connected to the lifting carriage in the travelling direction of the forklift truck and cannot tip, e.g. when pulling back after putting down a load. The figure shows the second fork tine 192 that is attached to the first holding profile 127 of the first guide profile 120 and the second holding profile 137 of the second guide profile 130 with its attachment profiles in 195. Furthermore, the first tappet plate 125 is shown in a section. The second tappet plate 135 is connected to the first drive element 121 of the first guide profile 120 with a screw as attachment means 121d via a cuboid elevation, wherein the cuboid elevation forms the first guide means 121e with the first longitudinal slit 122. Furthermore, the second guide profile 130 is visible in FIG. 4, which has the second cylinder housing 131b and the second piston rod 131c. Furthermore, the second longitudinal slit 132 and the strip 150 that covers the second longitudinal slit 132 as a protection element are visible. Both guide profiles 120, 130 reach around the drive element 121, 131 arranged inside them by approx. 90%. The guide profile 120, 130 reaching around the drive element 121, 131 protects the drive element 121, 131 in the guide profile 120, 130 and holds it so that it cannot bend or fold out even at application of great force.

FIG. 5 shows a section from above through the second guide profile 130. The connection head 131f is firmly connected to the frame and the second piston rod 131c is connected to the connection head 131f. The hydraulic oil runs through the second piston rod 131c via two ducts, once to the bottom side of the piston (load handling equipment moves apart) and once to the rod side of the piston in the second cylinder housing 131b (load handling equipment moves together). The second guide means 131e is connected to the movable second cylinder housing 131b. Sliding elements (not shown) are mounted between the second drive element 131 and the second guide profile 130. The first guide profile 120 is built accordingly.

FIG. 6 shows a three-dimensional illustration of a drive element 121, 131 with a tappet plate 125, 135. The piston rod 121c, 131c is shown, which is firmly installed in the guide profile 120, 130 (not shown), wherein the cylinder housing 121b, 131b can be moved. The tappet plate 125, 135 is attached to the cylinder housing 121b, 131b via the cuboid elevation as a holder using screws as attachment means 121d, 131d. The tappet plate 125, 135 has a U-shaped holding profile 126, 136. The connection head 121f, 131f is firmly connected to the piston rod 121d, 131c and carries the hydraulic connections 200. The connection head 121f, 131f further has an attachment means 121g, 131g in the form of a holding bore for a bolt for attachment to the guide profile 120, 130.

FIG. 7 shows a three-dimensional illustration of another embodiment of a drive element 121, 131 with a tappet plate 125, 135. In contrast to the embodiment shown in FIG. 6, the tappet plates 125, 135 are attached to a sliding arm 121h, 131h that is driven by the respective piston rod 121c, 131c.

FIG. 8 shows a three-dimensional front view of an alternative embodiment of the system according to the invention 100 with the second load handling element 192, which is attached to the first guide profile. The second tappet plate 135 is empty, so that the holding profile 136 is visible in the second tappet plate 135. The holding profile 136 in this embodiment also comprises a U-shaped profile sized in width so that the two legs of the U can partially enclose the load handling elements 191, 192 used. The tappet plates 125, 135 create the connection of the lateral shifting drive to the fork tines 191, 192. Standard fork tines 191, 192 can be used due to the shape of the holding profile 126, 136. In the embodiment shown in FIG. 8, each tappet plate 125, 135 is driven via the respective drive element 121, 131 in a guide profile 120, 130 and additionally guided by the other guide profile 130, 120 as well, wherein both the first longitudinal slit 122 and the second longitudinal slit 132 face forward, i.e. in the expansion direction of the load handling elements 191, 192. The respective tappet plates 125, 135 do not need to be guided by the respective other guide profile 120, 130, but may also be guided only by one guide profile 120, 130. Furthermore, an embodiment is possible where either both longitudinal slits 122, 132 face up, i.e. in the direction opposite to the horizontal parts of the load handling elements 191, 192. As another embodiment, a system 100 according to the invention is also possible where the first longitudinal slit 122 points downwards in the direction of the second guide profile 130 and the second longitudinal slit 132 points upwards in the direction of the first guide profile 120. An inverted arrangement of the guide slits 122, 132 as compared to this is possible as well.

FIG. 9 shows a three-dimensional illustration of another embodiment of a drive element 121 with tappet plates 125, 136. In contrast to the drive elements shown in FIGS. 6 and 7, the first and second drive elements shown in FIG. 9 are on one level and can, as a result, be installed in a guide profile (not illustrated). A drive unit 160 is located between the first drive element 121 and the second drive element 131. This drive unit 160 can be, e.g., an electrical or fluid motor, e.g. a hydro motor. In this embodiment, the drive unit 160 drives both the first drive element 121 and the second drive element 131 rotatingly. Spindles are installed as drive elements 121, 131, e.g. ball screws or threaded spindles. The drive elements 121, 131 move sliding arms 121h, 131h on which the tappet plates 125, 135 can be attached. A gear can be integrated into the drive unit (not illustrated), which can be switched and which can reverse the rotating direction of a drive element 121, 131, so that both a lateral shifting movement in which the tappet plates 125, 135 are moved in parallel and in the same direction, and an opposite movement of the tappet plates 125, 135, as it is required for adjustment of the distance of the load handling elements 191, 192 (not illustrated) are possible.

### REFERENCE SIGN LIST

100 System for handling and transporting loads
110 Device for handling and transporting loads
111 First attachment profile of the device
112 Second attachment profile of the device
120 First guide profile
121 First drive element
121a First fluid cylinder
121b First cylinder housing
121c First piston rod
121d First attachment means
121e First guide means
121f First connection head
121g First attachment means
121h First sliding arm
121i First spindle
122 First longitudinal slit
125 First tappet plate
126 Holding profile in the first tappet plate
127 First holding profile
130 Second guide profile
131 Second drive element
131a Second fluid cylinder
131b Second cylinder housing
131c Second piston rod
131d Second attachment means
131e Second guide means
131f Second connection head
131g Second attachment means
131h Second sliding arm
131i Second spindle
132 Second longitudinal slit
135 Second tappet plate
136 Holding profile in the second tappet plate
137 Second holding profile
140 Connection element
150 Protection element, strip
160 Drive unit
191 First load handling element, first fork tine
192 Second load handling element, second fork tine
195 Attachment profile
200 Hydraulic connection

1. A device for handling and transporting loads, to be mounted on a mobile or stationary facility, comprising at least a first guide profile, wherein at least two load handling elements can be mounted at the first guide profile, wherein the at least two load handling elements can be moved relative to each other or in parallel to each other in the longitudinal direction of the first guide profile respectively by at least one drive element,
characterised in that
the first guide profile has a hollow profile and that a drive element is at least partially integrated inside the first guide profile in the first guide profile, wherein a tappet plate is operatively connected to a drive element, and the guide of the tappet plate is also at least partially integrated and supported in the profile, wherein the drive element and the guide of the tappet plate are on one axis, wherein the first guide profile has a longitudinal slit through which the holder of the tappet plate protrudes, wherein one load handling element each can be operatively connected to a tappet plate, wherein the first guide profile carries the at least two load handling elements.

2. The device according to claim 1,
characterised in that
the device has a second guide profile arranged essentially in parallel to the first guide profile in addition to the first guide profile, wherein the guide profiles are connected to each other at a distance via at least one connection element arranged essentially vertically to the guide profiles.

3. The device according to claim 1,
characterised in that
each drive element can be operatively connected to a drive unit on the one side and to a tappet plate on the other side.

4. The device according to claim 3,
characterised in that
at least one drive element has a spindle.

5. The device according to claim 3,
characterised in that
at least one drive element has a fluid cylinder.

6. The device according to claim 3,
characterised in that
the drive unit has a hydro motor.

7. The device according to claim 3,
characterised in that
the drive unit has an electric motor.

8. The device according to claim 1,
characterised in that
only one guide profile has a drive element.

9. The device according to claim 2,
characterised in that
both guide profiles each have a drive element.

10. The device according to claim 2,
characterised in that
the at least one first guide profile and the at least one second guide profile are connected to each other at a distance by two connection elements arranged essentially vertically to the guide profiles.

11. The device according to claim 9,
characterised in that
both guide profiles each have a longitudinal slit, wherein the longitudinal slits point towards each other.

12. The device according to claim 11,
characterised in that
the two guide profiles are arranged essentially horizontally on top of each other, so that the first guide profile is located above the second guide profile and the second longitudinal slit of the second guide profile on the top of the second guide profile in the direction of the first guide profile, wherein the second longitudinal slit of the second guide profile is closed by protection element that is moved along with the second tappet plate.

13. The device according to claim 1,
characterised in that
at least one of the drive elements has a fluid-operated cylinder, comprising a cylinder housing and a piston rod, wherein attachment means and guide means for the tappet plate driven by the drive element is at least partially integrated in the cylinder housing.

14. The device according to claim 1,
characterised in that
at least one guide profile has an essentially rectangular outer cross-section with an essentially round cavity arrangement in the axis direction.

15. The device according to claim 1,
characterised in that
the longitudinal slit of the guide profile comprising a drive element is formed so that it holds the tappet plate in the vertical position and turning away of the tappet plate is prevented.

16. The device according to claim 9,
characterised in that
the first tappet plate is driven by the first drive element in the first guide profile and additionally guided by the second guide profile, and the second tappet plate is driven by the second drive element in the second guide profile and additionally guided by the first guide profile.

17. The device according to claim 1,
characterised in that
at least one guide profile reaches around the respective drive element at least by 75%.

18. The device according to claim 1,
characterised in that
each tappet plate has a holding profile for handling the respective load handling equipment, wherein the holding profile can be adjusted to the width of the load handling equipment.

19. A system for picking up and transporting loads for mounting on mobile or stationary facilities,
characterised in that
the System comprises at least a load handling element and a device according to claim 1.

20. The system according to claim 18,
characterised in that
the first guide profile has a holding profile with a protruding strip on one of its outer sides, wherein the at least one load handling element can be attached to the holding profile with an attachment profile worked mirror-inverted to the holding profile, wherein the attachment profile has a sliding piece that is applied to the protruding strip of the holding profile when the load handling element is attached to the holding profile.
